(19) United States
(12) Patent Application Publication
(10) Pub. No.: US 2014/0380249 A1
(43) Pub. Date: Dec. 25, 2014

(54) VISUAL RECOGNITION OF GESTURES

(71) Applicant: Apple Inc., Cupertino, CA (US)

(72) Inventor: Christopher Brian Fleizach, Morgan Hill, CA (US)

(73) Assignee: Apple Inc., Cupertino, CA (US)

(21) Appl. No.: 14/096,328

(22) Filed: Dec. 4, 2013

Related U.S. Application Data
(60) Provisional application No. 61/839,002, filed on Jun. 25, 2013.

(51) Int. Cl. G06F 3/01; G06F 3/0484

(52) U.S. Cl. CPC G06F 3/017; G06F 3/04845
USPC 715/863

(57) ABSTRACT

Techniques that enable a user to interact with an electronic device using spatial gestures without touching the electronic device. An electronic device provides a contactless mode of operation during which a user can interact with the electronic device using touchless gestures. A touchless gesture may be used to indicate an action to be performed and also to set an action-related parameter value that is then used when the action is performed.

### CROSS-REFERENCES TO RELATED APPLICATIONS

This application claims priority to Provisional Application No. 61/839,002, filed Jun. 25, 2013, titled “VISUAL RECOGNITION OF GESTURES”, which is hereby incorporated by reference in its entirety.

### BACKGROUND

The disclosed embodiments relate generally to electronic devices that are capable of recognizing touchless gestures and performing one or more actions in response to the touchless gestures.

Electronic devices generally provide user interfaces that enable a user of the device to interact with the device. As an example, many electronic devices provide one or more physical buttons or switches that users can touch and operate with their fingers to perform one or more actions. More recently, computing devices such as the iPhone®, iPod Touch®, and iPad® devices from Apple Inc. of Cupertino, Calif., provide touch-sensitive interfaces (sometimes referred to as touch screens) for user interaction. A touch screen on an electronic device can both display information to a user and also receive touch inputs from the user of the device. A user may, while touching the touch screen of an electronic device, perform a gesture, which is then interpreted by the device which performs an action in response to the gesture. For example, the user may tap on the touch screen to increase the magnification of an object displayed by the touch screen.

As electronic devices and their associated features increase in complexity, other forms of user interfaces may be useful.

### BRIEF DESCRIPTION OF THE DRAWINGS

FIG. 1 depicts a simplified diagram of an electronic device that may incorporate an embodiment;

FIG. 2 depicts a simplified diagram of an electronic device that may incorporate an embodiment;

FIG. 3 depicts a simplified diagram of an electronic device that may incorporate an embodiment;

FIG. 4 depicts a simplified diagram of an electronic device that may incorporate an embodiment;

FIG. 5 depicts a simplified diagram of an electronic device that may incorporate an embodiment;

FIG. 6 depicts a simplified diagram of an electronic device that may incorporate an embodiment;

FIG. 7 depicts a simplified flowchart illustrating a method for touchless interaction with an electronic device according to some embodiments;

FIG. 8 depicts a simplified flowchart illustrating a method for touchless interaction with an electronic device according to some embodiments;

FIG. 9 depicts a simplified flowchart illustrating a method for touchless interaction with an electronic device according to some embodiments;

FIG. 10 depicts a simplified flowchart illustrating a method for touchless interaction with an electronic device according to some embodiments;

FIG. 11 depicts a simplified flowchart illustrating a method for touchless interaction with an electronic device according to some embodiments;

FIG. 12 depicts a simplified flowchart illustrating a method for touchless interaction with an electronic device according to some embodiments;

FIG. 13 depicts a simplified diagram of a system that may incorporate an embodiment;

FIG. 14 is a simplified block diagram of a computer system that may incorporate components of a system for performing an action in response to a gesture according to some embodiments; and

FIG. 15 depicts a simplified diagram of a distributed system for performing an action in response to a gesture according to some embodiments.

### DETAILED DESCRIPTION

In the following description, for the purposes of explanation, specific details are set forth in order to provide a thorough understanding of embodiments of the invention. However, it will be apparent that various embodiments may be practiced without these specific details.

Certain embodiments are described that enable a user to interact with an electronic device using spatial gestures without touching the electronic device. In one embodiment, the electronic device provides a contactless mode of operation during which a user can interact with the electronic device without touching the device. For purposes of this disclosure, a gesture made by a user with respect to an electronic device without touching or contacting the electronic device may be referred to as a contactless gesture or a touchless gesture. A touchless gesture may include the motion of an object relative to the electronic device, the motion of one or more portions of an object relative to the electronic device or simply the detection of a stationary object. In certain embodiments, a touchless gesture may be used to indicate an action to be performed by an electronic device and also to set an action-related parameter value that is then used when the action is performed.

As described above, certain embodiments enable a user of an electronic device to interact with the device using one or more touchless gestures made by the user. A user may make a touchless gesture, for example, using the user's hand or finger or other part of the user's body. However, this is not intended to be restrictive. In some other embodiments, a touchless gesture may be made by the user using an object such as a pen, a stylus, and the like. In general, a user may make a touchless gesture using an object such as the user's hand or finger, or some other object. The user may use both the position of the object and/or the motion of the object relative to the device to provide input to the device.

In certain embodiments, an electronic device is configured to detect one or more touchless gestures made by a user relative to the device and perform one or more actions in response to and based upon the one or more touchless gestures. For example, in one instance, the electronic device may be configured to detect the distance between the user's hand and the electronic device. The touchless gesture made by the user, or some other gesture, may be used to determine an action to be performed by the electronic device. The value of a parameter associated with the action may then be set based upon the detected distance between the user's hand and the electronic device. The electronic device may then perform the action using the parameter value. For example, the action that is performed may be a zoom or pan operation. The distance of the user's hand from the electronic device may be used to set the value of a zoom or pan rate parameter. In one instance, the value of the zoom or pan rate may be proportional to the distance of the user's hand from the electronic device (e.g., a smaller distance may correspond to a smaller zoom or pan rate value and a greater distance may correspond to a higher zoom or pan rate value). The zoom or pan operation may then be performed using the set zoom or pan rate value.

In certain other embodiments, a user of an electronic device may make repetitive touchless gestures with respect to the electronic device. These repetitive touchless gestures may be detected by the electronic device and used to set a value of a parameter on the electronic device. The same gestures or a different user gesture may be used to determine an action to be performed by the electronic device. The value of a parameter associated with the action may then be set based upon the number of repetitive gestures. The electronic device may then perform the determined action, using the parameter value. Examples of repetitive touchless gestures include, but are not limited to, repetitive swipes of the user's hand in front of the device, and other touchless gestures. In one instance, the value of the zoom or pan rate may be proportional to the number of times the user's hand passes in front of the electronic device (e.g., a lesser number may correspond to a smaller zoom or pan rate value and a greater number may correspond to a higher zoom or pan rate value). The zoom or pan operation may then be performed using the set zoom or pan rate value.

In certain embodiments, the velocity associated with a touchless user gesture relative to the electronic device may be used to set a parameter associated with the action to be performed. The same gesture or a different touchless user gesture may be used to determine the action to be performed, and to set the parameter value. The electronic device may then perform the action, where the performance of the action is based on or influenced by the parameter value.

The touchless gestures described above may be performed by the user in a spatial zone around the electronic device. For example, in one instance, a touchless gesture may be performed in a zone in front of the electronic device, such as in front of a touch screen of the electronic device. In another instance, the touchless gesture may be performed in a zone behind the electronic device away from the touch screen. The touchless gesture may also be performed in other zones around the electronic device.

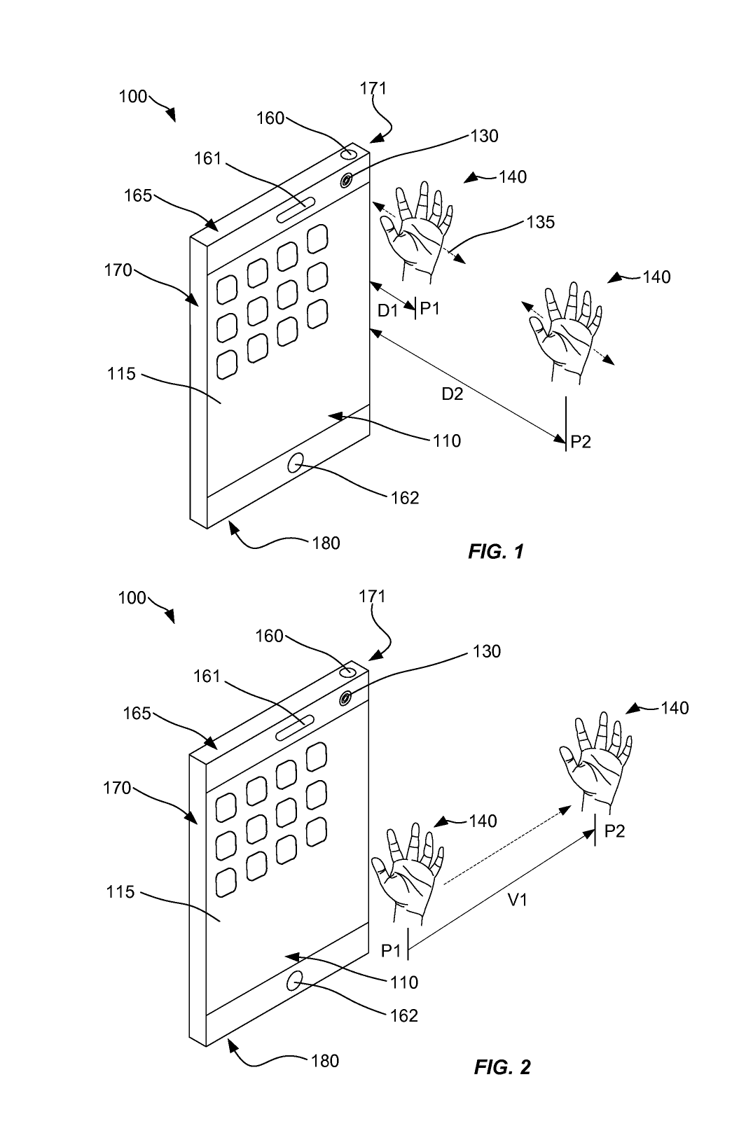

FIG. 1 depicts a simplified diagram of an example electronic device 100 that may incorporate an embodiment. In the embodiment depicted in FIG. 1, electronic device 100 includes a front face 110 having a display screen 115, a sensor 130, a speaker 161, and a home button 162. Display screen 115 may be any type of display including but not limited to a liquid crystal display, an LED display, an electroluminescent display, a plasma display, an organic light emitting diode display, or a touch sensitive display. In the embodiment depicted in FIG. 1, electronic device 100 is a rectangular prism having a back face positioned opposite front face 110, a top face 165 positioned opposite a bottom face 180, and a left face 170 positioned opposite a right face 171. Top face 165 may include a receptacle connector 160. Although the embodiment in FIG. 1 shows only one display screen, sensor, speaker, receptacle connector and button, it is understood that myriad configurations and quantities of these features are possible without departing from the invention.

In certain embodiments, electronic device 100 may be placed into a contactless mode where it is configured to recognize touchless gestures and use them as input. Myriad methods may be used to enable the contactless mode such as by selecting a button or switch on electronic device 100, performing a touch gesture on electronic device 100, etc.

FIG. 1 depicts an object 140 (illustrated as a portion of a user's hand) positioned in front of front face 110. Object 140 is depicted in a first position at a distance D1 from electronic device 100 performing a touchless gesture. Object 140 is also shown as able to move along path 135 closer to electronic device 100 and/or further away from the electronic device. When operating in contactless mode, sensor 130 of electronic device 100 may be used to detect the presence of object 140 and the performance of one or more touchless gestures by object 140.

In some embodiments, sensor 130 and/or other sensors, may be employed by electronic device 100 to detect one or more attribute values related to the touchless gestures of object 140. Examples of attribute values include but are not restricted to the position-related attributes of object 140 with respect to electronic device (e.g., linear distance of object 140 from face 115 of electronic device 100), motion-related attributes of the touchless gesture such as speed, velocity, acceleration, direction of motion of object 140 while making the touchless gesture, and the like. Input from sensor 130 and/or from other sensors, may be employed by electronic device 100 to detect one or more attributes of the touchless gesture.

In certain embodiments, electronic device 100 may determine an action to be performed corresponding to the detected touchless gesture. Electronic device 100 may then identify a parameter associated with the action and set a value of the parameter based on the value of an attribute (or multiple attributes) of the touchless gesture. Electronic device 100 may then perform the action using the parameter value. In certain embodiments, the results of performing the action may be output to the user using display 115 or some other output system of electronic device 100.

As described above, a value of an attribute of a touchless gesture is used to set the value of a parameter associated with an action to be performed. The action is then performed using the parameter value. In one embodiment, an attribute value is determined for a touchless gesture and the same touchless gesture is used to determine the action to be performed. In a second embodiment, the attribute value may be determined for a first touchless gesture and a second touchless gesture may be input to determine the action to be performed. Accordingly, in the second embodiment, at least two touchless gestures are used.

As an illustrative example of an embodiment, electronic device 100 may execute a map application that displays a map on display 115. The user may wish to zoom the displayed map at a particular zoom rate without touching electronic device 100. The user may activate a contactless mode of operation on electronic device 100. This may be done in various different ways as discussed in more detail below. In one embodiment, device 100 may be configured to enter a contactless mode when the user's finger swipes over a sensor of device 100. Once in contactless mode, the electronic device may be able to detect and receive one or more touchless inputs.

For example, in one embodiment, the user may perform the touchless gesture of positioning and holding steady his/her hand with palm open for a preconfigured period of time in front of sensor 130. When such a touchless gesture is sensed by electronic device 100, the electronic device may be configured to detect an attribute value of the touchless gesture. In one embodiment the attribute value may be the distance of the user's hand from electronic device 100. For sake of example, in FIG. 1 it is assumed that device 100 detects user's open hand 140 at position P1 and detects the distance D1 of the hand from the front face of electronic device 100. For example, distance D1 may be determined to be 25 centimeters.

At the same time, or subsequently, electronic device 100 may use the same gesture (open hand in front of electronic device) or different gesture to determine an action to be performed. For example, in certain embodiments, the user may input a second touchless gesture to indicate an action to be performed. In one embodiment, the user may indicate that a zoom-out operation is to be performed by moving the user's hand in a direction away from the front face of electronic device 100; the user may indicate that a zoom-in operation is to be performed by moving the user's hand in a direction towards the front face of electronic device 100; the user may indicate that a pan-left action is to be performed by moving the user′ hand in a left direction parallel to the front face of electronic device 100; or indicate that a pan-right action is to be performed by moving the user′ hand in a right direction parallel to the front face of electronic device 100; and the like. Electronic device 100 is configured to detect the second gesture and determine the action to be performed. In some embodiments, electronic device 100 may use a lookup table or other mechanism to correlate specific gestures to particular actions.

For example, electronic device 100 may determine that a zoom-in or zoom-out operation is to be performed based upon the second touchless gesture. Electronic device 100 may then set the zoom rate associated with the zoom operation based upon the value of the distance attribute. Accordingly, the zoom rate may be set based upon the detected distance D1. Electronic device may then perform the action (zoom-in or zoom-out operation) based on the set parameter value.

Electronic device 100 may use various different techniques to map an attribute value to the value to be assigned to a parameter of the action to be performed. In one embodiment, for a particular action to be performed, electronic device 100 may be configured to select a pre-determined parameter of the action (e.g., the zoom rate for a zoom operation). Electronic device 100 may then use a lookup table or other method that correlates distances to zoom rate values. Using such a table, an object distance of 25 centimeters is correlated to a specific zoom rate (e.g., 10 times per centimeter). In some other embodiments, one or more equations (or some other logic) may be used to translate the value of an attribute of a touchless gesture to the value of a parameter of the action to be performed.

Electronic device may then perform the action (zoom-in or zoom-out operation) based on the set parameter value (e.g., 10 times per centimeter). Thus, if user's hand 140 moves from its starting position of 25 centimeters to a new position of 26 centimeters, the display will zoom out by ten times to ten times the starting display area. Conversely, if the user's hand moves from 25 centimeters to 24 centimeters, the display will zoom in by ten times, to one tenth of the initial display area. The result of the zoom-in or zoom-out may then be sent to and output to the user via display 115 or may be sent to any other system.

As a further example, in another embodiment, the user may change the action-related parameter value (e.g., zoom rate) by changing the initial position of the user's hand relative to electronic device 100. As illustrated in FIG. 1, the user may perform the first touchless gesture of positioning and holding steady his/her hand with palm open for a preconfigured period of time in position P2 front of sensor 130 at a new distance D2 that is greater than D1. For example, D2 may be approximately 100 centimeters from electronic device 100. Electronic device 100 may determine the attribute value of the gesture is now a distance of 100 centimeters. Electronic device 100 may then determine that this new distance corresponds to a zoom rate of 15 times per centimeter of user's hand 140 motion.

In the manner described above, electronic device 100 is configured to enable a user of electronic device 100 to indicate an action to be performed and also control the value of a parameter associated with the action to be performed using one or more touchless gestures. Certain embodiments provide an alternative touchless interface for interacting with electronic device 100.

In certain embodiments, electronic device 100 may provide feedback to the user when a gesture has been recognized and the value of an attribute of the gesture measured. In one example, electronic device 100 may output an audible tone or display an indicator on the touch screen to indicate that the gesture has been recognized and the value of an attribute of the gesture has been successfully determined.

FIG. 2 depicts a simplified diagram of example electronic device 100 that may incorporate another embodiment. Electronic device 100 may be placed into a contactless mode where it is configured to recognize touchless gestures and use them as input. For example, in one embodiment, the user may perform a touchless gesture of positioning his/her hand with palm open at position P1 and then moving his/her hand from P1 to a position P2. When operating in contactless mode, electronic device 100 is configured to detect the occurrence of such a touchless gesture and identify the gesture performed by the user. Electronic device 100 may also be configured to detect or measure the value of an attribute of the touchless gesture. For example, in one embodiment, the attribute value may be the velocity V1 of the user's hand in its motion from P1 to P2 relative to electronic device 100. In some instances, electronic device 100 may calculate the velocity for the user's hand moving from P1 to P2 to be approximately 25 centimeters-per-second. The attribute value (e.g., the velocity of the user's hand relative to the electronic device) may then be used to set the value of an action-related parameter. For example, for a zoom operation, the velocity may be used to determine a zoom rate value.

At the same time as detecting the attribute value, or subsequently, electronic device 100 may also recognize a gesture of object 140 and determine the corresponding action to be performed. For example, in one embodiment, electronic device 100 recognizes the gesture as a user's hand moving from position P1 to position P2. Electronic device then determines the corresponding action to be performed as a display pan. In some embodiments, electronic device may use a lookup table or other mechanism to correlate specific gestures to particular actions.

Electronic device 100 then uses the attribute value to set the value of a parameter associated with the action to be performed. In this example, electronic device determines that an attribute value of 25 centimeters per second corresponds to a panning parameter value of 10 centimeters per second. Electronic device may then pan the display from left to right at a rate of 10 centimeters per second, or the device may notify the user that the attribute value has been determined and the user's next gesture will determine the pan direction at the rate of 10 centimeters per second.

In another embodiment, if the user desired a different pan rate, the user could reactivate the contactless mode and move their hand from position P1 to position P2 at a velocity V1 of 100 centimeters per second. Electronic device may then use the new attribute value of 100 centimeters per second to set the parameter value (pan rate) to, for example, 30 centimeters per second. Thus the user can vary the pan rate by moving their hand at a different velocity from P1 to P2, and user can change the action of panning by performing a different gesture. These features enable the use of a contactless mode of interacting with electronic device 100.

In some embodiments, a first gesture of object 140 may be repeated and the number of times the first gesture is repeated may be detected as an attribute value of the first gesture. For example, as illustrated in FIG. 2, object 140 may be positioned in front of front face 110 and moved from position P1 to position P2 three times. In some embodiments, the repetitions may need to be performed within an allotted time period, and at the end of the time period the electronic device may audibly or visually alert the user that the first gesture time period has expired. The device may use the number of gestures to set the attribute value.

A second gesture may be used as an input to the device to determine an action to perform such as, for example, a pan or a zoom. For example, the user may perform a second gesture such as swiping their hand in front of the electronic device after the allotted time period. Electronic device 100 may determine that this second gesture corresponds to a pan action.

The electronic device, now knowing the action is a pan, may correlate the attribute value (three repetitions) to a parameter value associated with the action (e.g., pan rate of 10 centimeters per second). In some embodiments the first gesture may be detected for a first object and the second gesture may be detected for a second object. In further embodiments one or more first sensors may be used to detect the first gesture and one or more second sensors may be used to detect the second gesture.

Sensors 130, 132 illustrated in FIGS. 1 and 2 are only for illustrative use and may include any sensing device capable of detecting the distance of an object and/or the motion of an object. For example, some embodiments may employ one or more optical imaging sensors that convert an optical image into an electronic signal. Example sensors may include charge-coupled device (CCD) or complementary metal-oxide-semiconductor (CMOS) active pixel sensors. Such sensors can be used in conjunction with a central processing unit and an image processing algorithm to determine the velocity of an object, a gesture of an object and the distance of an object from the electronic device. The determination of the velocity and gesture of an object are relatively straight forward using commercially available “blob detection” and “blob analysis” vision software. The change in distance of an object may be determined by employing the change in apparent size of the object in the image and the actual distance may be determined by starting the object from a known starting point such as touching the sensor or a location proximate the sensor. Other algorithms are known to those of skill in the art and may also be employed.

Further embodiments may employ one or more ultrasonic sensors. Such sensors work on a principle similar to radar or sonar. Ultrasonic sensors generate high frequency sound waves and evaluate the echo which is received back by the sensor. Sensors calculate the time interval between sending the signal and receiving the echo to determine the distance to an object. Some sensors have transmitters that are separate from the receivers while others may be a substantially unitary device comprising both a transmitter and a receiver. In some embodiments a plurality of ultrasonic sensors are used which can form a reasonably detailed “sound-based” image of the object. Ultrasonic sensors can be used in conjunction with a central processing unit to determine the velocity, acceleration and rotation of an object, a gesture of an object and the distance of an object from the electronic device.

Still further embodiments may employ a non-imaging optical sensor. Such sensors work similar to the ultrasonic sensors discussed above, however instead of generating high frequency sound waves these sensors generate light waves which are reflected back to the sensor by the object. The light source may be, for example, infra-red, white light, a laser or other type of light. The sensors calculate the time interval and sometimes the frequency and/or phase shift between sending the signal and receiving the echo to determine the distance to an object. Some sensors may also be able to determine the direction of the reflected light and use that to detect the position or distance of the object. Some non-imaging optical sensors have transmitters that are separate from the receivers while others may be a substantially unitary device including both a transmitter and a receiver. In some embodiments a plurality of non-imaging optical sensors are used which can form a reasonably detailed “light-based” image of the object. Non-imaging optical sensors can be used in conjunction with a central processing unit to determine the velocity, acceleration and rotation of an object, a gesture of an object and the distance of an object from the electronic device.

Other embodiments may employ one or more other sensors such as a proximity sensor, a hall-effect sensor, a radar sensor, a thermal sensor, etc. Myriad sensors may be used and are known by those of skill in the art. Further embodiments may employ more than one sensor and the plurality of sensors may be used by themselves or in conjunction with each other. Some embodiments may have more than one sensor of the same type disposed on a single face while other embodiments may have sensors of different types disposed on a single face. Further embodiments may have sensors disposed on separate faces. For example, in one embodiment both an optical imaging sensor and a non-imaging optical sensor may be disposed on rear face 112 of electronic device 100. The optical imaging sensor may be used to determine the velocity of the object while the non-imaging optical sensor may be used to determine the distance of the object from the electronic device. In further embodiments a non-imaging optical sensor may be disposed on left face 170 of the electronic device and an optical imaging sensor may be disposed on front face 110 of the device. The non-imaging optical sensor may be used to activate a contactless sensing mode of electronic device 100 and the optical imaging sensor may be used to determine the velocity of an object, a gesture of an object and the distance of an object from the electronic device. Myriad combinations and locations of sensors may be employed on electronic device 100.

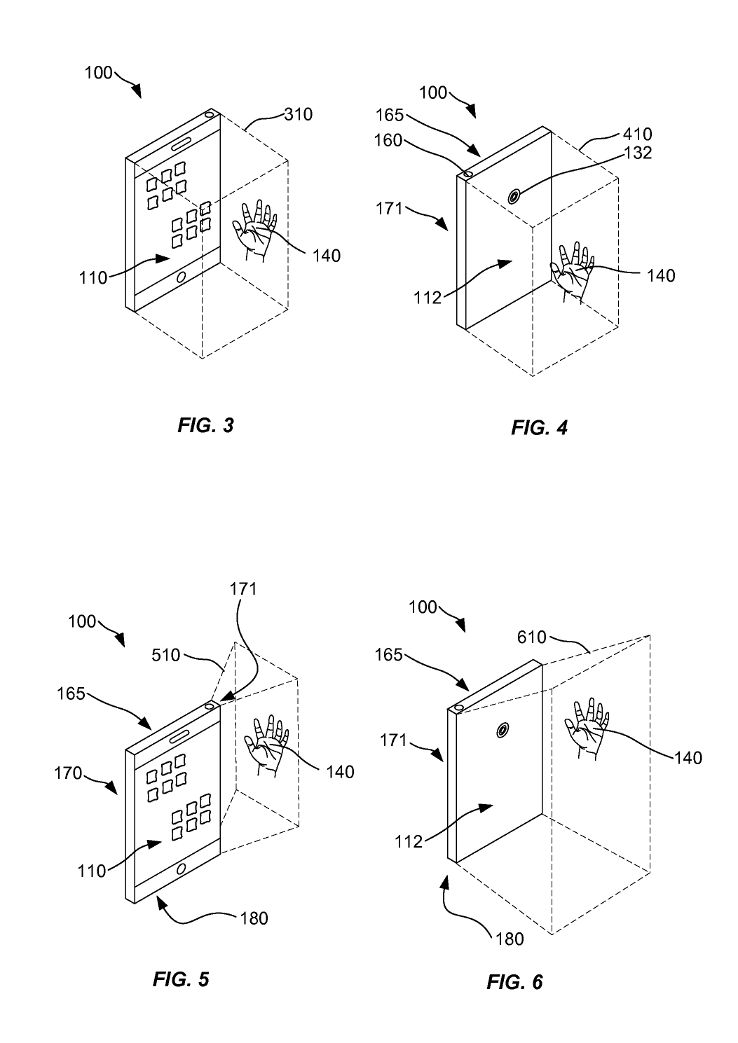

In the examples described above, the touchless gestures were performed in front of the front face of electronic device 100. This is however not intended to be limiting. Electronic device 100 may provide for multiple sensing zones in which touchless gestures are detected by electronic device 100 as shown in the examples illustrated in FIGS. 3-6. As depicted in these figures, sensing zones may be located in front of any surface of electronic device 100 and may be any shape including extending over multiple planes of the electronic device. For example, sensing zone 310 illustrated in FIG. 3 represents space in front of the front face of electronic device 100 in which electronic device 100 is configured to sense and detect one or more touchless gestures. The touchless gestures in sensing zone 310 may be detected by one or more sensors disposed on electronic device 100. Sensing zone 310 is for illustrative purposes only and in some embodiments sensing zone may be larger, smaller and/or of different geometry.

FIG. 4 depicts an example where a sensing zone 410 disposed at the rear of electronic device 100 in front of rear face 112 of electronic device 100. In one embodiment, sensing zone 410 may be enabled by sensors provided by electronic device 10, for example, a sensor 132 provided on rear face 112 of electronic device 100. In some embodiments, sensor 132 may be used to detect object 140 and attribute values of the object. For example, sensor 132 may be used to detect positional attribute values (e.g., distance of object 140 from electronic device 100) and/or motion-related attribute values associated with the touchless gesture (e.g., velocity, acceleration, rotation, gestures, repetitive gestures, etc.).

FIG. 5 illustrates a sensing zone 510 disposed in front of right face 171 of electronic device 100. Sensing zone 510 may extend outwardly as illustrated, intersecting other planes of electronic device 100 such as front face 110 and rear face 112. FIG. 6 illustrates an alternative sensing zone disposed in front of rear face 112 of electronic device 100. Sensing zone 610 may extend outwardly as illustrated, intersecting other planes of electronic device 100, such as top face 165, right face 171, left face 170 and bottom face 180. Myriad configurations of sensing zones may be used by themselves or in combination with each other.

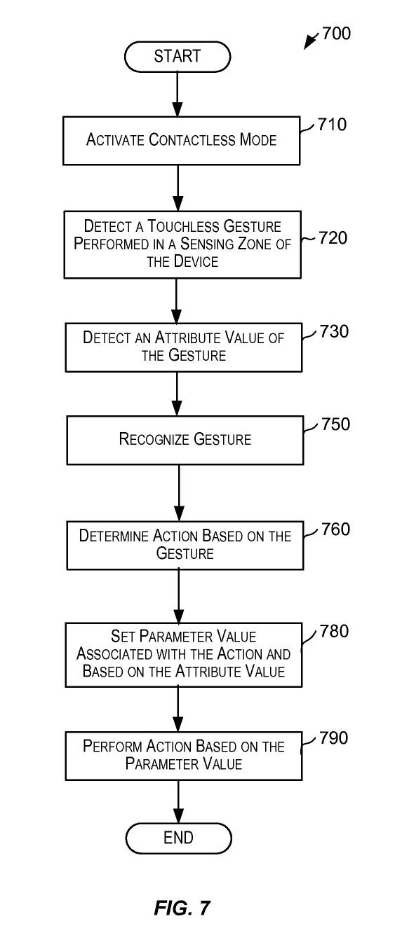

FIG. 7 depicts a simplified flowchart 700 illustrating a general method for performing an action in response to one or more touchless gestures according to some embodiments. The processing depicted in FIG. 7 may be implemented in software (e.g., code, instructions, program) executed by one or more processors, in hardware, or combinations thereof. The software may be stored on a non-transitory computer-readable storage medium (e.g., stored on a memory device). The particular series of processing steps depicted in FIG. 7 is not intended to be limiting.

As depicted in FIG. 7, the method may be initiated at 710 upon activation of a contactless mode for an electronic device. There are various ways in which the contactless mode can be activated. In some embodiments, the contactless mode may be activated by selecting one or more buttons on electronic device 100. In other embodiments, the mode may be selected using one or more user-selectable options provided by electronic device 100. For example, a user may use a touch screen on a device such as an iPhone® or iPad® to select a user-selectable option to cause the contactless mode to be initiated. In certain other embodiments, a user may interact with one or more sensors of electronic device 100 to activate the contactless mode. For example, a user may use their finger to cover a sensor on electronic device 100 or the user may interact with the device in another way such as pressing a depressible button, rotating the device and/or bumping the device against an object. In other embodiments the contactless mode may be automatically activated by the electronic device as a part of a preprogrammed algorithm. For example, if a user selects the map function on the device the device may automatically activate contactless mode. Other methods may be used to activate the contactless mode and are within the scope of this disclosure. The method of activating the contactless mode may be preconfigured from the manufacturer or it may be user configurable.

At 720, electronic device 100 senses and determines a touchless gesture being performed by an object (e.g., a user's hand) in a sensing zone of electronic device 100. For example, the touchless gesture may be detected by one or more sensors on the device. In one embodiment an optical sensor may be used that projects an optical signal out from the electronic device and detects light that reflects off the object and determines the touchless gesture based upon the measurements of the reflection. In other embodiments, an ultrasonic or other type of sensor may be used, including an imaging sensor. In some embodiments several sensors (e.g., a motion sensor) may be used in conjunction with each other to detect the object and the gesture being performed. Touchless gesture detection may be preconfigured from the manufacturer or it may be user configurable.

Examples of touchless gestures include, without restriction, an object moving relative to the electronic device or the object remaining stationary in front of the electronic device. In other embodiments, a gesture relative to the device may include portions of the object moving relative to each other and to the device. For example, two fingers of a hand moving close together or further apart may be a gesture. As another example, a rotation of one's hand may also be a gesture, where there is no translation of the object, but only rotation. As yet another example, complex gestures may be recognized such as, but not limited to, one's hand transitioning from a fingers extended position to a fist. All of these movements may be considered gestures relative to the device, but in no way do these examples limit what may be considered gestures relative to the device. Gesture detection may be preconfigured from the manufacturer or it may be user configurable.

At 730, the values for one or more attributes of the touchless gesture are detected. Examples of attributes include, without limitation, the distance of the object performing the gesture from the electronic device, the velocity of object making the gesture, the number of repetitions of the gesture, and the like. Myriad other attribute values may be detected using one or more sensors of the electronic device.

At 750, the electronic device may optionally determine a second touchless gesture being performed indicative of the action to be performed. The processing in 750 may not be performed in an environment where the same single gesture is used for attribute value measurement and for indicating the action to be performed.

At 760, electronic device determines an action to be performed. This determination may be based upon the gesture of the object detected in 720 or the gesture detected in 750. For example, a touchless gesture comprising an object moving from left to right with respect to the electronic device may correspond to a panning action to be performed from left to right. As another example, a touchless gesture comprising two fingers moving apart may indicate a zoom operation to be performed.

At 780, a value of a parameter associated with the action determined in 760 is set based on the attribute value determined in 730. As previously indicated, various different techniques may be used to identify the parameter whose value is to be set and further to determine a value for the parameter based upon the attribute value. In certain embodiments, the parameter may be selected based upon the action to be performed. For example, if a zoom operation is to be performed then the zoom rate is selected as the parameter; if a pan operation is to be performed then the pan rate is selected as the parameter; if a page scroll operation is to be performed then the number of lines (or other page portion) to be scrolled may be the selected parameter; and the like. Accordingly, the action-related parameter may be dependent upon the action to be performed. In one embodiment, the electronic device may store and access a mapping table that maps an action to be performed to the parameter to be selected for that action.

As part of 780, once the action-associated parameter has been selected, the value for the parameter is determined based upon the attribute value (or multiple values) determined in 730. Various different techniques may be used to determine the parameter value from an attribute value. These include without limitation a lookup or mapping table that correlates the attribute value to an action-associated parameter value, one or more equations (or some other logic) that computes the parameter value based upon one or more attribute values, and the like. In certain embodiments, the relationship between the attribute value and the parameter value may be pre-programmed by the manufacturer or it may be user configurable.

For example, if the parameter is a pan rate or a zoom rate, a distance attribute value such as 25 centimeters from the electronic device may be translated to a pan or zoom rate of 5 millimeters per second. As another example, if the distance attribute value is 100 centimeters, the pan or zoom rate may be set to 30 millimeters per second.

At 790, the action determined in 760 is performed using the parameter value determined in 780. For example, if the parameter is a pan rate set to 5 millimeters per second, then the information displayed by electronic device 100 may be panned at a rate of 5 mm/s. Other embodiments may perform other actions such as zoom, scroll, dimming the display, etc. Myriad other variants are within the scope of this disclosure.

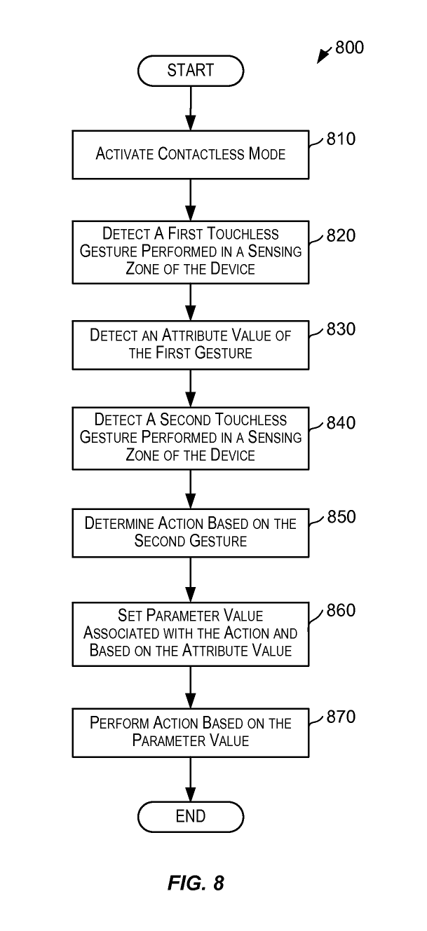

FIG. 8 depicts a simplified flowchart 800 illustrating a general method for performing an action based on a parameter according to some embodiments. The processing depicted in FIG. 8 may be implemented in software (e.g., code, instructions, program) executed by one or more processors, hardware, or combinations thereof. The software may be stored on a non-transitory computer-readable storage medium. The particular series of processing steps depicted in FIG. 8 is not intended to be limiting.

As depicted in FIG. 8, the method may be initiated at 810 upon activation of a contactless mode for an electronic device. There are various ways in which the contactless mode can be activated. In some embodiments, the contactless mode may be activated by selecting one or more buttons on electronic device 100. In other embodiments, the mode may be selected using one or more user-selectable options provided by electronic device 100. For example, a user may use a touch screen on a device such as an iPhone® or iPad® to select a user-selectable option to cause the contactless mode to be initiated. In certain other embodiments, a user may interact with one or more sensors of electronic device 100 to activate the contactless mode. For example, a user may use their finger to cover a sensor on electronic device 100 or the user may interact with the device in another way such as pressing a depressible button, rotating the device and/or bumping the device against an object. In other embodiments the contactless mode may be automatically activated by the electronic device as a part of a preprogrammed algorithm. For example, if a user selects the map function on the device the device may automatically activate contactless mode. Other methods may be used to activate the contactless mode and are within the scope of this disclosure. The method of activating the contactless mode may be preconfigured from the manufacturer or it may be user configurable.

At 820, electronic device 100 senses and determines a first touchless gesture being performed by an object (e.g., a user's hand) in a sensing zone of electronic device 100. For example, the touchless gesture may be detected by one or more sensors on the device. In one embodiment an optical sensor may be used that projects an optical signal out from the electronic device and detects light that reflects off the object and determines the touchless gesture based upon the measurements of the reflection. In other embodiments, an ultrasonic or other type of sensor may be used, including an imaging sensor. In some embodiments several sensors (e.g., a motion sensor) may be used in conjunction with each other to detect the object and the gesture being performed. Touchless gesture detection may be preconfigured from the manufacturer or it may be user configurable.

Examples of touchless gestures include, without restriction, an object moving relative to the electronic device or the object remaining stationary in front of the electronic device. In other embodiments, a gesture relative to the device may include portions of the object moving relative to each other and to the device. For example, two fingers of a hand moving close together or further apart may be a gesture. As another example, a rotation of one's hand may also be a gesture, where there is no translation of the object, but only rotation. As yet another example, complex gestures may be recognized such as, but not limited to, one's hand transitioning from a fingers extended position to a fist. All of these movements may be considered gestures relative to the device, but in no way do these examples limit what may be considered gestures relative to the device. Gesture detection may be preconfigured from the manufacturer or it may be user configurable.

At 830, the values for one or more attributes of the first touchless gesture are detected. Examples of attributes include, without limitation, the distance of the object performing the gesture from the electronic device, the velocity of object making the gesture, the number of repetitions of the gesture, and the like. Myriad other attribute values may be detected using one or more sensors of the electronic device.

At 840, electronic device 100 senses and determines a second touchless gesture being performed by an object (e.g., a user's hand) in a sensing zone of electronic device 100. For example, the touchless gesture may be detected by one or more sensors on the device. In one embodiment an optical sensor may be used that projects an optical signal out from the electronic device and detects light that reflects off the object and determines the touchless gesture based upon the measurements of the reflection. In other embodiments, an ultrasonic or other type of sensor may be used, including an imaging sensor. In some embodiments several sensors (e.g., a motion sensor) may be used in conjunction with each other to detect the object and the gesture being performed. Touchless gesture detection may be preconfigured from the manufacturer or it may be user configurable.

Examples of touchless gestures include, without restriction, an object moving relative to the electronic device or the object remaining stationary in front of the electronic device. In other embodiments, a gesture relative to the device may include portions of the object moving relative to each other and to the device. For example, two fingers of a hand moving close together or further apart may be a gesture. As another example, a rotation of one's hand may also be a gesture, where there is no translation of the object, but only rotation. As yet another example, complex gestures may be recognized such as, but not limited to, one's hand transitioning from a fingers extended position to a fist. All of these movements may be considered gestures relative to the device, but in no way do these examples limit what may be considered gestures relative to the device. Gesture detection may be preconfigured from the manufacturer or it may be user configurable.

At 850, electronic device determines an action to be performed. This determination may be based upon the gesture of the object detected in 840. For example, a touchless gesture comprising an object moving from left to right with respect to the electronic device may correspond to a panning action to be performed from left to right. As another example, a touchless gesture comprising two fingers moving apart may indicate a zoom operation to be performed.

At 860, a value of a parameter associated with the action determined in 850 is set based on the attribute value determined in 830. As previously indicated, various different techniques may be used to identify the parameter whose value is to be set and further to determine a value for the parameter based upon the attribute value. In certain embodiments, the parameter may be selected based upon the action to be performed. For example, if a zoom operation is to be performed then the zoom rate is selected as the parameter; if a pan operation is to be performed then the pan rate is selected as the parameter; if a page scroll operation is to be performed then the number of lines (or other page portion) to be scrolled may be the selected parameter; and the like. Accordingly, the action-related parameter may be dependent upon the action to be performed. In one embodiment, the electronic device may store and access a mapping table that maps an action to be performed to the parameter to be selected for that action.

As part of 860, once the action-associated parameter has been selected, the value for the parameter is determined based upon the attribute value (or multiple values) determined in 830. Various different techniques may be used to determine the parameter value from an attribute value. These include without limitation a lookup or mapping table that correlates the attribute value to an action-associated parameter value, one or more equations (or some other logic) that computes the parameter value based upon one or more attribute values, and the like. In certain embodiments, the relationship between the attribute value and the parameter value may be pre-programmed by the manufacturer or it may be user configurable.

For example, if the parameter is a pan rate or a zoom rate, a distance attribute value such as 25 centimeters from the electronic device may be translated to a pan or zoom rate of 5 millimeters per second. As another example, if the distance attribute value is 100 centimeters, the pan or zoom rate may be set to 30 millimeters per second.

At 870, the action determined in 850 is performed using the parameter value set in 860. For example, if the parameter is a pan rate set to 5 millimeters per second, then the information displayed by electronic device 100 may be panned at a rate of 5 mm/s. Other embodiments may perform other actions such as zoom, scroll, dimming the display, etc. Myriad other variants are within the scope of this disclosure.

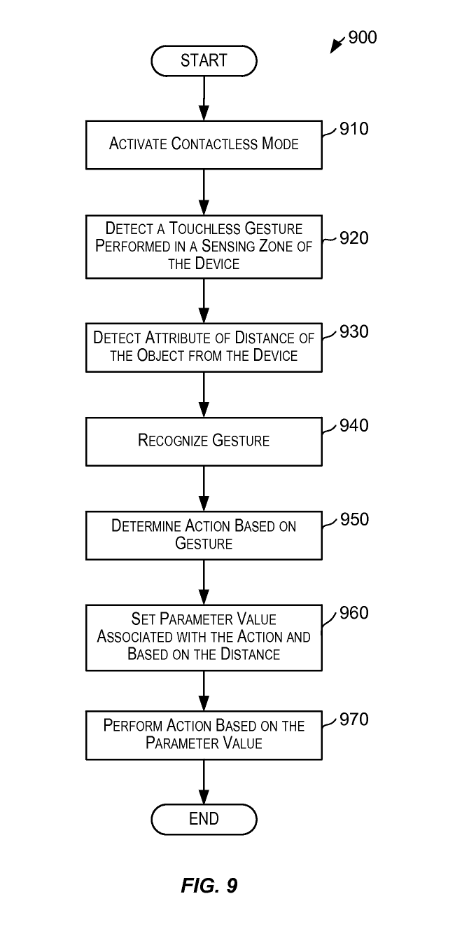

FIGS. 9-12 depict simplified flowcharts illustrating more specific examples of how general methods 700 and 800 (See FIGS. 7 and 8) may be performed.

FIG. 9 depicts a simplified flowchart 900 illustrating a general method for performing an action in response to one or more touchless gestures according to some embodiments. The processing depicted in FIG. 9 may be implemented in software (e.g., code, instructions, program) executed by one or more processors, in hardware, or combinations thereof. The software may be stored on a non-transitory computer-readable storage medium (e.g., stored on a memory device). The particular series of processing steps depicted in FIG. 9 is not intended to be limiting.

As depicted in FIG. 9, the method may be initiated at 910 upon activation of a contactless mode for an electronic device. There are various ways in which the contactless mode can be activated. In some embodiments, the contactless mode may be activated by selecting one or more buttons on electronic device 100. In other embodiments, the mode may be selected using one or more user-selectable options provided by electronic device 100. For example, a user may use a touch screen on a device such as an iPhone® or iPad® to select a user-selectable option to cause the contactless mode to be initiated. In certain other embodiments, a user may interact with one or more sensors of electronic device 100 to activate the contactless mode. For example, a user may use their finger to cover a sensor on electronic device 100 or the user may interact with the device in another way such as pressing a depressible button, rotating the device and/or bumping the device against an object. In other embodiments the contactless mode may be automatically activated by the electronic device as a part of a preprogrammed algorithm. For example, if a user selects the map function on the device the device may automatically activate contactless mode. Other methods may be used to activate the contactless mode and are within the scope of this disclosure. The method of activating the contactless mode may be preconfigured from the manufacturer or it may be user configurable.

At 920, electronic device 100 senses and determines a touchless gesture being performed by an object (e.g., a user's hand) in a sensing zone of electronic device 100. For example, the touchless gesture may be detected by one or more sensors on the device. In one embodiment an optical sensor may be used that projects an optical signal out from the electronic device and detects light that reflects off the object and determines the touchless gesture based upon the measurements of the reflection. In other embodiments, an ultrasonic or other type of sensor may be used, including an imaging sensor. In some embodiments several sensors (e.g., a motion sensor) may be used in conjunction with each other to detect the object and the gesture being performed. Touchless gesture detection may be preconfigured from the manufacturer or it may be user configurable.

Examples of touchless gestures include, without restriction, an object moving relative to the electronic device or the object remaining stationary in front of the electronic device. In other embodiments, a gesture relative to the device may include portions of the object moving relative to each other and to the device. For example, two fingers of a hand moving close together or further apart may be a gesture. As another example, a rotation of one's hand may also be a gesture, where there is no translation of the object, but only rotation. As yet another example, complex gestures may be recognized such as, but not limited to, one's hand transitioning from a fingers extended position to a fist. All of these movements may be considered gestures relative to the device, but in no way do these examples limit what may be considered gestures relative to the device. Gesture detection may be preconfigured from the manufacturer or it may be user configurable.

At 930, an attribute value of the gesture which is the distance between the object and the electronic device, is detected. In some embodiments, the distance may be determined using optical sensors, ultrasonic sensors and/or imaging sensors, or other methods. In further embodiments, the distance may be determined from a particular face of the electronic device and may further be determined from one or more sensors disposed on a face of the electronic device. In still further embodiments a plurality of imaging sensors may determine the distance between the object and the device. Detection of the distance between the object and the device may be preconfigured from the manufacturer or it may be user configurable.

At 940, the electronic device may optionally determine a second touchless gesture being performed indicative of the action to be performed. The processing in 940 may not be performed in an environment where the same single gesture is used for attribute value measurement and for indicating the action to be performed.

At 950, electronic device determines an action to be performed. This determination may be based upon the gesture of the object detected in 920 or the gesture detected in 940. For example, a touchless gesture comprising an object moving from left to right with respect to the electronic device may correspond to a panning action to be performed from left to right. As another example, a touchless gesture comprising two fingers moving apart may indicate a zoom operation to be performed.

At 960, a value of a parameter associated with the action determined in 950 is set based on the attribute value (distance of the object from the device) determined in 930. As previously indicated, various different techniques may be used to identify the parameter whose value is to be set and further to determine a value for the parameter based upon the attribute value. In certain embodiments, the parameter may be selected based upon the action to be performed. For example, if a zoom operation is to be performed then the zoom rate is selected as the parameter; if a pan operation is to be performed then the pan rate is selected as the parameter; if a page scroll operation is to be performed then the number of lines (or other page portion) to be scrolled may be the selected parameter; and the like. Accordingly, the action-related parameter may be dependent upon the action to be performed. In one embodiment, the electronic device may store and access a mapping table that maps an action to be performed to the parameter to be selected for that action.

As part of 960, once the action-associated parameter has been selected, the value for the parameter is determined based upon the attribute value (or multiple values) determined in 930. Various different techniques may be used to determine the parameter value from an attribute value. These include without limitation a lookup or mapping table that correlates the attribute value to an action-associated parameter value, one or more equations (or some other logic) that computes the parameter value based upon one or more attribute values, and the like. In certain embodiments, the relationship between the attribute value and the parameter value may be pre-programmed by the manufacturer or it may be user configurable.

For example, if the parameter is a pan rate or a zoom rate, a distance attribute value such as 25 centimeters from the electronic device may be translated to a pan or zoom rate of 5 millimeters per second. As another example, if the distance attribute value is 100 centimeters, the pan or zoom rate may be set to 30 millimeters per second.

At 970, the action determined in 950 is performed using the parameter value determined in 960. For example, if the parameter is a pan rate set to 5 millimeters per second, then the information displayed by electronic device 100 may be panned at a rate of 5 mm/s. Other embodiments may perform other actions such as zoom, scroll, dimming the display, etc. Myriad other variants are within the scope of this disclosure.

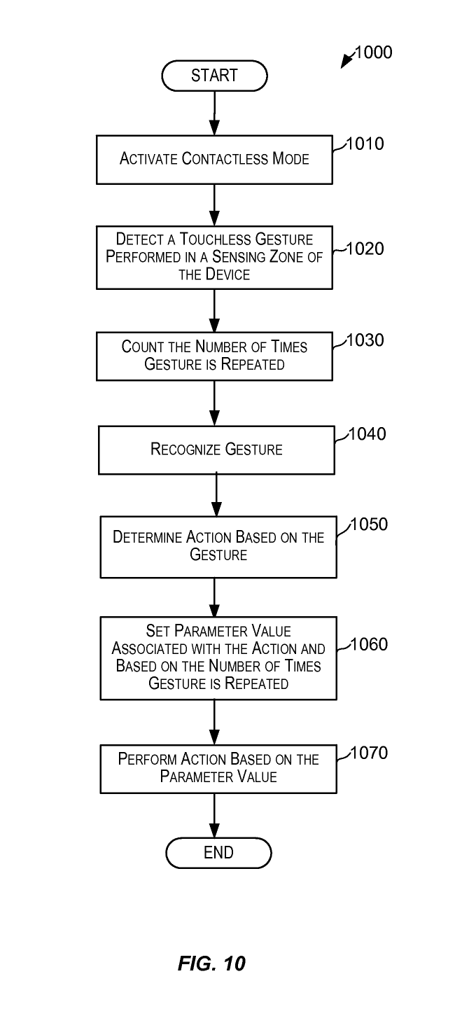

FIG. 10 depicts a simplified flowchart 1000 illustrating a general method for performing an action in response to one or more touchless gestures according to some embodiments. The processing depicted in FIG. 10 may be implemented in software (e.g., code, instructions, program) executed by one or more processors, in hardware, or combinations thereof. The software may be stored on a non-transitory computer-readable storage medium (e.g., stored on a memory device). The particular series of processing steps depicted in FIG. 10 is not intended to be limiting.

As depicted in FIG. 10, the method may be initiated at 1010 upon activation of a contactless mode for an electronic device. There are various ways in which the contactless mode can be activated. In some embodiments, the contactless mode may be activated by selecting one or more buttons on electronic device 100. In other embodiments, the mode may be selected using one or more user-selectable options provided by electronic device 100. For example, a user may use a touch screen on a device such as an iPhone® or iPad® to select a user-selectable option to cause the contactless mode to be initiated. In certain other embodiments, a user may interact with one or more sensors of electronic device 100 to activate the contactless mode. For example, a user may use their finger to cover a sensor on electronic device 100 or the user may interact with the device in another way such as pressing a depressible button, rotating the device and/or bumping the device against an object. In other embodiments the contactless mode may be automatically activated by the electronic device as a part of a preprogrammed algorithm. For example, if a user selects the map function on the device the device may automatically activate contactless mode. Other methods may be used to activate the contactless mode and are within the scope of this disclosure. The method of activating the contactless mode may be preconfigured from the manufacturer or it may be user configurable.

At 1020, electronic device 100 senses and determines a touchless gesture being performed by an object (e.g., a user's hand) in a sensing zone of electronic device 100. For example, the touchless gesture may be detected by one or more sensors on the device. In one embodiment an optical sensor may be used that projects an optical signal out from the electronic device and detects light that reflects off the object and determines the touchless gesture based upon the measurements of the reflection. In other embodiments, an ultrasonic or other type of sensor may be used, including an imaging sensor. In some embodiments several sensors (e.g., a motion sensor) may be used in conjunction with each other to detect the object and the gesture being performed. Touchless gesture detection may be preconfigured from the manufacturer or it may be user configurable.

At 1030, an attribute value of the gesture which is the number of times the gesture is repeated, is detected. In some embodiments, the number of repetitions may be determined using optical sensors, ultrasonic sensors and/or imaging sensors, or other methods. In further embodiments, the number of repetitions may be determined from a particular face of the electronic device and may further be determined from one or more sensors disposed on a face of the electronic device. In still further embodiments a plurality of imaging sensors may determine the number of repetitions. Detection of the number of repetitions may be preconfigured from the manufacturer or it may be user configurable.

At 1040, the electronic device may optionally determine a second touchless gesture being performed indicative of the action to be performed. The processing in 1040 may not be performed in an environment where the same single gesture is used for attribute value measurement and for indicating the action to be performed.

At 1050, electronic device determines an action to be performed. This determination may be based upon the gesture of the object detected in 1020 or the gesture detected in 1040. For example, a touchless gesture comprising an object moving from left to right with respect to the electronic device may correspond to a panning action to be performed from left to right. As another example, a touchless gesture comprising two fingers moving apart may indicate a zoom operation to be performed.

At 1060, a value of a parameter associated with the action determined in 1050 is set based on the attribute value (number of times the gesture is repeated) determined in 1030. As previously indicated, various different techniques may be used to identify the parameter whose value is to be set and further to determine a value for the parameter based upon the attribute value. In certain embodiments, the parameter may be selected based upon the action to be performed. For example, if a zoom operation is to be performed then the zoom rate is selected as the parameter; if a pan operation is to be performed then the pan rate is selected as the parameter; if a page scroll operation is to be performed then the number of lines (or other page portion) to be scrolled may be the selected parameter; and the like. Accordingly, the action-related parameter may be dependent upon the action to be performed. In one embodiment, the electronic device may store and access a mapping table that maps an action to be performed to the parameter to be selected for that action.

As part of 1060, once the action-associated parameter has been selected, the value for the parameter is determined based upon the attribute value (or multiple values) determined in 1030. Various different techniques may be used to determine the parameter value from an attribute value. These include without limitation a lookup or mapping table that correlates the attribute value to an action-associated parameter value, one or more equations (or some other logic) that computes the parameter value based upon one or more attribute values, and the like. In certain embodiments, the relationship between the attribute value and the parameter value may be pre-programmed by the manufacturer or it may be user configurable.

For example, if the parameter is a pan rate or a zoom rate, a number of repetitions attribute value such as 2 times may be translated to a pan or zoom rate of 5 millimeters per second. As another example, if the number of repetitions attribute value is 4 times, the pan or zoom rate may be set to 30 millimeters per second.

At 1070, the action determined in 1050 is performed using the parameter value determined in 1060. For example, if the parameter is a pan rate set to 5 millimeters per second, then the information displayed by electronic device 100 may be panned at a rate of 5 mm/s. Other embodiments may perform other actions such as zoom, scroll, dimming the display, etc. Myriad other variants are within the scope of this disclosure.

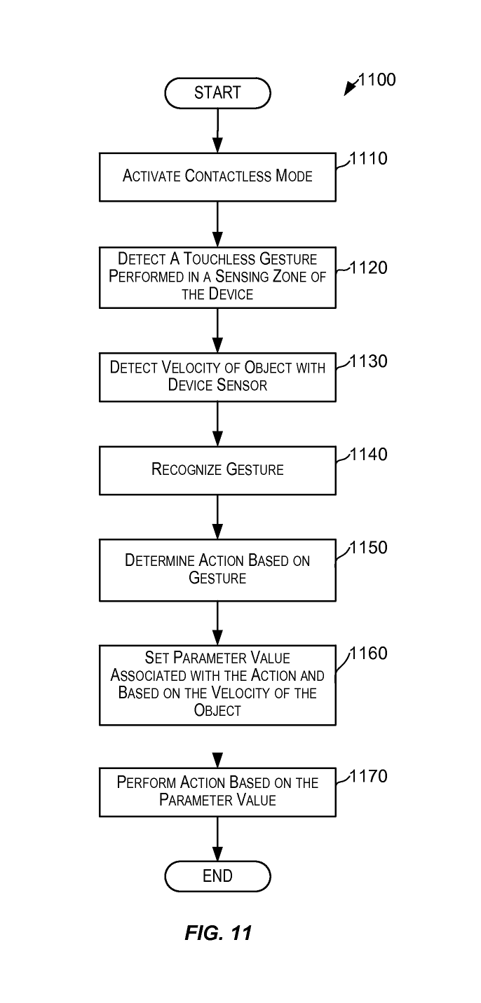

FIG. 11 depicts a simplified flowchart 1100 illustrating a general method for performing an action in response to one or more touchless gestures according to some embodiments. The processing depicted in FIG. 11 may be implemented in software (e.g., code, instructions, program) executed by one or more processors, in hardware, or combinations thereof. The software may be stored on a non-transitory computer-readable storage medium (e.g., stored on a memory device). The particular series of processing steps depicted in FIG. 11 is not intended to be limiting.

As depicted in FIG. 11, the method may be initiated at 1110 upon activation of a contactless mode for an electronic device. There are various ways in which the contactless mode can be activated. In some embodiments, the contactless mode may be activated by selecting one or more buttons on electronic device 100. In other embodiments, the mode may be selected using one or more user-selectable options provided by electronic device 100. For example, a user may use a touch screen on a device such as an iPhone® or iPad® to select a user-selectable option to cause the contactless mode to be initiated. In certain other embodiments, a user may interact with one or more sensors of electronic device 100 to activate the contactless mode. For example, a user may use their finger to cover a sensor on electronic device 100 or the user may interact with the device in another way such as pressing a depressible button, rotating the device and/or bumping the device against an object. In other embodiments the contactless mode may be automatically activated by the electronic device as a part of a preprogrammed algorithm. For example, if a user selects the map function on the device the device may automatically activate contactless mode. Other methods may be used to activate the contactless mode and are within the scope of this disclosure. The method of activating the contactless mode may be preconfigured from the manufacturer or it may be user configurable.

At 1120, electronic device 100 senses and determines a touchless gesture being performed by an object (e.g., a user's hand) in a sensing zone of electronic device 100. For example, the touchless gesture may be detected by one or more sensors on the device. In one embodiment an optical sensor may be used that projects an optical signal out from the electronic device and detects light that reflects off the object and determines the touchless gesture based upon the measurements of the reflection. In other embodiments, an ultrasonic or other type of sensor may be used, including an imaging sensor. In some embodiments several sensors (e.g., a motion sensor) may be used in conjunction with each other to detect the object and the gesture being performed. Touchless gesture detection may be preconfigured from the manufacturer or it may be user configurable.

Examples of touchless gestures include, without restriction, an object moving relative to the electronic device or the object remaining stationary in front of the electronic device. In other embodiments, a gesture relative to the device may include portions of the object moving relative to each other and to the device. For example, two fingers of a hand moving close together or further apart may be a gesture. As another example, a rotation of one's hand may also be a gesture, where there is no translation of the object, but only rotation. As yet another example, complex gestures may be recognized such as, but not limited to, one's hand transitioning from a fingers extended position to a fist. All of these movements may be considered gestures relative to the device, but in no way do these examples limit what may be considered gestures relative to the device. Gesture detection may be preconfigured from the manufacturer or it may be user configurable.

At 1130, an attribute value of the gesture which is the velocity of the object, is detected. In some embodiments, the velocity of the object may be determined using optical sensors, ultrasonic sensors and/or imaging sensors, or other methods. In further embodiments, the velocity of the object may be determined from a particular face of the electronic device and may further be determined from one or more sensors disposed on a face of the electronic device. In still further embodiments a plurality of imaging sensors may determine the velocity of the object. Detection of the velocity of the object may be preconfigured from the manufacturer or it may be user configurable.

At 1140, the electronic device may optionally determine a second touchless gesture being performed indicative of the action to be performed. The processing in 1140 may not be performed in an environment where the same single gesture is used for attribute value measurement and for indicating the action to be performed.

At 1150, the electronic device determines an action to be performed. This determination may be based upon the gesture of the object detected in 1120 or the gesture detected in 1140. For example, a touchless gesture comprising an object moving from left to right with respect to the electronic device may correspond to a panning action to be performed from left to right. As another example, a touchless gesture comprising two fingers moving apart may indicate a zoom operation to be performed.

At 1160, a value of a parameter associated with the action determined in 1150 is set based on the attribute value determined in 1130. As previously indicated, various different techniques may be used to identify the parameter whose value is to be set and further to determine a value for the parameter based upon the attribute value. In certain embodiments, the parameter may be selected based upon the action to be performed. For example, if a zoom operation is to be performed then the zoom rate is selected as the parameter; if a pan operation is to be performed then the pan rate is selected as the parameter; if a page scroll operation is to be performed then the number of lines (or other page portion) to be scrolled may be the selected parameter; and the like. Accordingly, the action-related parameter may be dependent upon the action to be performed. In one embodiment, the electronic device may store and access a mapping table that maps an action to be performed to the parameter to be selected for that action.

As part of 1160, once the action-associated parameter has been selected, the value for the parameter is determined based upon the attribute value (or multiple values) determined in 1130. Various different techniques may be used to determine the parameter value from an attribute value. These include without limitation a lookup or mapping table that correlates the attribute value to an action-associated parameter value, one or more equations (or some other logic) that computes the parameter value based upon one or more attribute values, and the like. In certain embodiments, the relationship between the attribute value and the parameter value may be pre-programmed by the manufacturer or it may be user configurable.

For example, if the parameter is a pan rate or a zoom rate, a velocity attribute value such as 25 centimeters per second may be translated to a pan or zoom rate of 5 millimeters per second. As another example, if the velocity attribute value is 100 centimeters per second, the pan or zoom rate may be set to 30 millimeters per second.

At 1170, the action determined in 1150 is performed using the parameter value determined in 1160. For example, if the parameter is a pan rate set to 5 millimeters per second, then the information displayed by electronic device 100 may be panned at a rate of 5 mm/s. Other embodiments may perform other actions such as zoom, scroll, dimming the display, etc. Myriad other variants are within the scope of this disclosure.

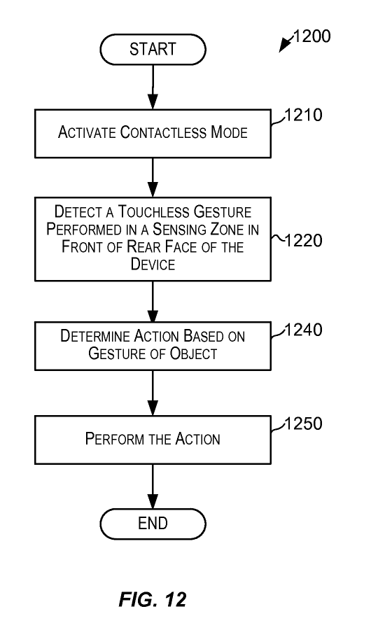

FIG. 12 depicts a simplified flowchart 1200 illustrating a general method for performing an action in response to one or more touchless gestures according to some embodiments. The processing depicted in FIG. 12 may be implemented in software (e.g., code, instructions, program) executed by one or more processors, in hardware, or combinations thereof. The software may be stored on a non-transitory computer-readable storage medium (e.g., stored on a memory device). The particular series of processing steps depicted in FIG. 12 is not intended to be limiting.

As depicted in FIG. 12, the method may be initiated at 1210 upon activation of a contactless mode for an electronic device. There are various ways in which the contactless mode can be activated. In some embodiments, the contactless mode may be activated by selecting one or more buttons on electronic device 100. In other embodiments, the mode may be selected using one or more user-selectable options provided by electronic device 100. For example, a user may use a touch screen on a device such as an iPhone® or iPad® to select a user-selectable option to cause the contactless mode to be initiated. In certain other embodiments, a user may interact with one or more sensors of electronic device 100 to activate the contactless mode. For example, a user may use their finger to cover a sensor on electronic device 100 or the user may interact with the device in another way such as pressing a depressible button, rotating the device and/or bumping the device against an object. In other embodiments the contactless mode may be automatically activated by the electronic device as a part of a preprogrammed algorithm. For example, if a user selects the map function on the device the device may automatically activate contactless mode. Other methods may be used to activate the contactless mode and are within the scope of this disclosure. The method of activating the contactless mode may be preconfigured from the manufacturer or it may be user configurable.

At 1220, electronic device 100 senses and determines a touchless gesture being performed by an object (e.g., a user's hand) in a sensing zone in front of rear face 112 (see FIG. 4) of electronic device 100. For example, the touchless gesture may be detected by one or more sensors on the device. In one embodiment an optical sensor may be used that projects an optical signal out from the electronic device and detects light that reflects off the object and determines the touchless gesture based upon the measurements of the reflection. In other embodiments, an ultrasonic or other type of sensor may be used, including an imaging sensor. In some embodiments several sensors (e.g., a motion sensor) may be used in conjunction with each other to detect the object and the gesture being performed. Touchless gesture detection may be preconfigured from the manufacturer or it may be user configurable.

At 1240 an action to be performed is determined based upon the gesture of the object detected in 1220. Thus, once the gesture is detected and understood by the system, the system may determine what action to perform based on the gesture. For example, a touchless gesture comprising an object moving from left to right with respect to the electronic device may correspond to a panning action to be performed from left to right. As another example, a touchless gesture comprising two fingers moving apart may indicate a zoom operation to be performed.

At 1250 an action may be performed based on the gesture. More specifically, the action determined at 1240 may be performed based on the gesture detected in 1220. As an example, in some embodiments the gesture may be a hand moving from the left to the right in front of the rear face of the device and the action may be to pan the display from the left to the right. Other embodiments may perform other actions based on gestures such as zoom, scroll, or dimming the display. Myriad other variants are within the scope of this disclosure.

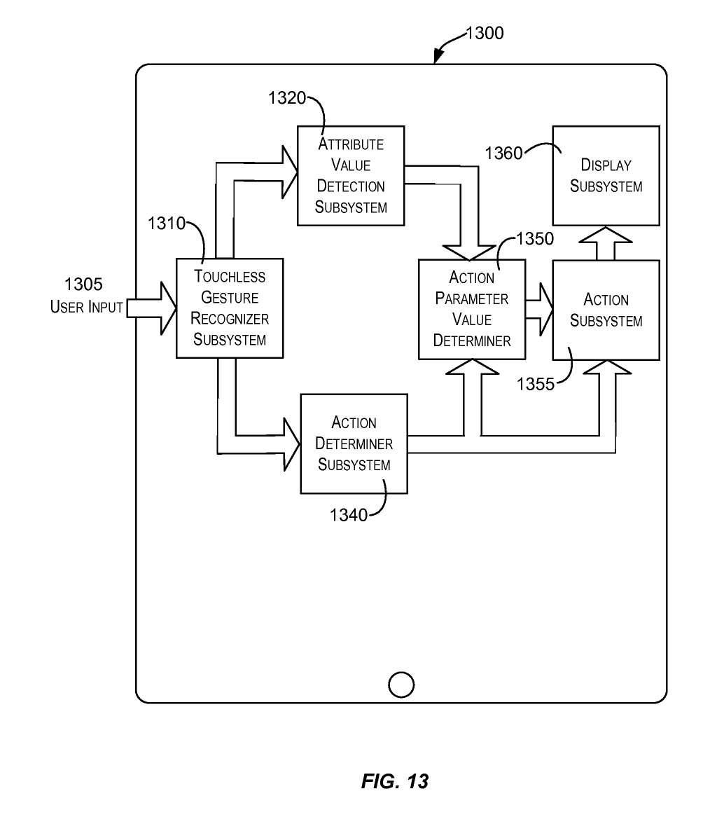

FIG. 13 depicts a simplified diagram of a system 1300 that may incorporate an embodiment. System 1300 may be fully or partially incorporated in an electronic device such as electronic device 100 depicted in FIG. 1. In the embodiment depicted in FIG. 13, system 1300 includes multiple subsystems including a touchless gesture recognizer subsystem 1310, an attribute value detection subsystem 1320, an action determiner subsystem 1340, an action parameter value determiner 1350, an action subsystem 1355 and a display subsystem 1360. The various subsystems depicted in FIG. 13 may be implemented in software, in hardware, or a combination thereof. In some embodiments, the software may be stored on a transitory or non-transitory computer readable medium and executed by one or more processors.

It should be appreciated that system 1300 depicted in FIG. 13 may have other components and/or subsystems than those depicted in FIG. 13. Further, the embodiment shown in FIG. 13 is only one example of a system that may incorporate an embodiment of the invention. In some other embodiments, system 1300 may have more or fewer components and/or subsystems than shown in FIG. 13, may combine two or more components and/or subsystems, or may have a different configuration or arrangement of components and/or subsystems. In some embodiments, system 1300 may be part of a portable communications device, such as a mobile telephone, a smart phone, or a multifunction device. Exemplary embodiments of portable devices include, without limitation, the iPhone®, iPod Touch®, and iPad® devices from Apple Inc. of Cupertino, Calif. In some other embodiments, system 1300 may also be incorporated in other devices such as desktop computers, kiosks, and the like.

System 1300 may be capable of receiving one or more user inputs 1305, including inputs in the form of touchless gestures. In certain embodiments, touchless gesture recognizer subsystem 1310 may be configured to sense and detect touchless gestures upon activation of a contactless mode of the electronic device. Touchless gesture recognizer subsystem 1310 may comprise one or more sensors. Using one or more of these sensors, touchless gesture recognizer subsystem 1310 may be configured to sense the presence and movement of an object (e.g., a user's hand) within a sensing zone of electronic device 100. For example, touchless gesture recognizer subsystem 1310 may be configured to determine a distance of the object making a touchless gesture from the electronic device. Touchless gesture recognizer subsystem 1310 may also be configured to track the movement of the object within the sensing zone and determine the velocity and/or direction of motion of the object in the sensing zone. In certain embodiments, touchless gesture recognizer subsystem 1310 may also be configured to sense and count repetitive touchless gestures made by the user in the sensing zone of the electronic device. In one embodiment, touchless gesture recognizer subsystem 1310 may then transmit the received/captured information to attribute value detection subsystem 1320 and to action determiner subsystem 1340 for further processing. Touchless gesture recognizer subsystem 1310 may be preconfigured from the manufacturer or it may be user configurable.

Attribute value detection subsystem 1320 may be configured to process the touchless gesture data received from touchless gesture recognizer subsystem 1310 and determine one or more attribute values from the data. For example, in one instance, attribute value detection subsystem 1320 may detect the distance of the object from the electronic device when the touchless gesture was made, the velocity of the object relative to the electronic device while making the touchless gesture, and/or the number of times the object passes in front of the electronic device. Myriad attribute values of the object may be detected by attribute value detection subsystem 1320.

Action determiner subsystem 1340 may be configured to process the touchless gesture data received from touchless gesture recognizer subsystem 1310 and determine an action to perform. As part of this processing, action determiner subsystem 1340 may be configured to determine the specific touchless gesture that is performed and an action corresponding to the touchless gesture. For example, action determiner subsystem 1340 may determine that the object has moved, what direction it has moved and how fast it has moved. Such movements may correspond to a particular gesture and action determiner subsystem 1340 may then determine an action to perform in response to that particular gesture.

Action determiner subsystem 1340 may also determine if a portion of an object has moved relative to another portion of the object, relating to a particular gesture. For example, if two fingers of a hand have moved together or apart, action determiner subsystem 1340 may be used to recognize this gesture and determine an action in response. Action determiner subsystem 1340 may use myriad methods to determine what action to perform in response to the gesture, including recognizing particular objects, such as a hand. In some embodiments, action determiner subsystem 1340 may use a lookup table to determine what action to perform in response to different gestures. Action determiner subsystem 1340 may then communicate information indicative of the action to be performed to action parameter value determiner 1350 and to action subsystem 1355. More specifically, in some embodiments where a lookup table is used, the user may customize which actions are to be performed in response to particular gestures.

Action parameter value determiner 1350 may be configured to, based upon information received from attribute value detection subsystem 1320 and action determiner subsystem 1340, select an action-associated parameter and then compute a value for the determined parameter. Action parameter value determiner 1350 may receive information indicative of the action to be performed from action determiner subsystem 1340 and use this information to determine a parameter associated with the action (e.g., select a zoom rate with the operation to be performed in a zoom operation). Once the parameter has been identified, action parameter value determiner 1350 may use the attribute value(s) received from attribute value detection subsystem 1320 to computer a value for that parameter. As described above, various techniques may be used to set determine a value for the parameter. Action parameter value determiner 1350 may communicate information indicative of the parameter value to action subsystem 1355 for execution of the action.

For example, in some embodiments, when a touchless gesture is performed in the context of a map application executed by the electronic device, attribute value detection subsystem 1320 may be configured to determine the distance between the electronic device and the object making the touchless gesture and transmit the distance information to action parameter value determiner 1350 for further processing. Action determiner subsystem 1340 may determine that the action to be performed is a pan from right to left of the map. Action determiner subsystem 1340 may transfer that information to action parameter value determiner 1350. Action parameter value determiner 1350 may then use the pan from right to left information to determine a parameter value based on the distance information. For example, in some embodiments, action parameter value determiner 1350 may set a parameter value (pan rate) for the action (pan from right to left), which is based on the distance of the object from electronic device 100. More specifically, in one embodiment, if an object is within 25 centimeters of electronic device 100, action parameter value determiner 1350 may set the map pan rate to 5 millimeters per second. However, in another embodiment, if an object is further than 100 centimeters from electronic device 100, then action parameter value determiner 1350 may set the map pan rate to 30 millimeters per second. This is just one example and myriad other variants are within the scope of this disclosure. Action parameter value determiner 1350 may then transfer parameter value data to action subsystem 1355. Action parameter value determiner 1350 may be preconfigured from the manufacturer or it may be user configurable.

Action subsystem 1355 receives information identifying the action to be performed from action determiner subsystem 1340 and receives information indicative of action-associated parameter value from action parameter value determiner 1350. Action subsystem 1355 is configured to cause the action to be performed or executed using the parameter value.

For example, in the context of a map application executed by electronic device 100, action subsystem 1355 may receive a pan rate value (e.g. pan rate of 5 millimeters per second) from action parameter value determiner 1350 and receive information indicating that a left-to-right panning action is to be performed from action determiner subsystem 1340. In certain embodiments, action subsystem 1355 may then perform the action of panning the map from the right of the device to the left of the device at a rate of 5 millimeters per second. In some embodiments, action subsystem may use the services of other subsystems (not shown in FIG. 13) to cause the action to be performed. Results of performing the action may be displayed on display subsystem 1360 of system 1300. This is just one example and myriad other variants are within the scope of this disclosure.

Display subsystem 1360 may be configured to output results of performing the action to a user of electronic device 100. For example, for a left-to-right panning operation at a rate of 5 millimeters per second, the results of the panning may be displayed using display subsystem 1360. While, the embodiment in FIG. 13 shows a display subsystem, the results of the action are not restricted to just visual data. In certain other embodiments, the action may result in other types of data being generated such as audio data, haptic data, etc. These results may be output using other types of output systems (e.g., audio data is output using an audio output subsystem, etc.).

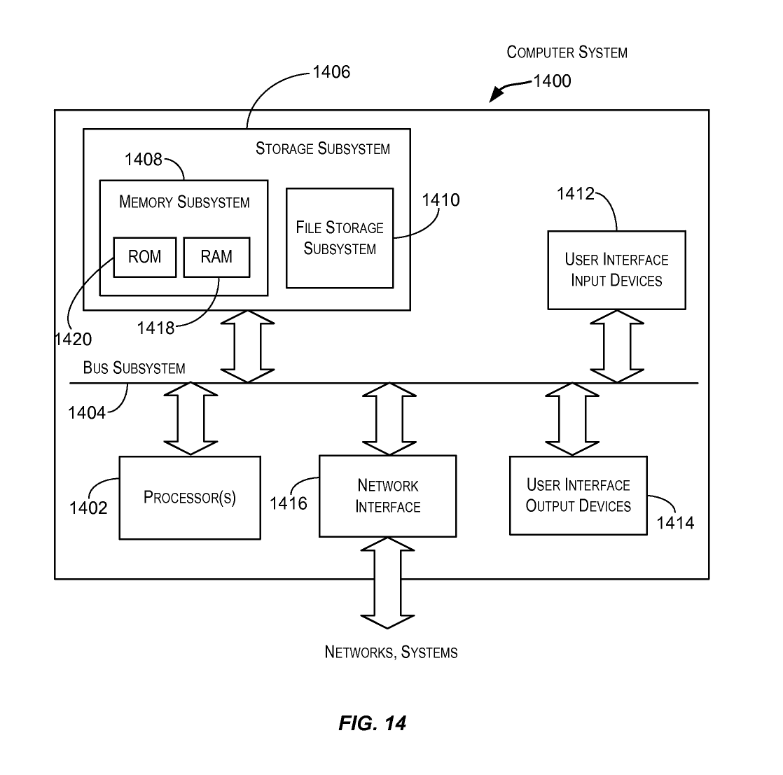

Electronic device 100 depicted in FIG. 1 may incorporate various systems and functions. FIG. 14 is a simplified block diagram of a computer system 1400 that may incorporate components of electronic device 100 according to some embodiments. As shown in FIG. 14, computer system 1400 includes a processor 1402 that communicates with a number of peripheral subsystems via a bus subsystem 1404. These peripheral subsystems may include a storage subsystem 1406, including a memory subsystem 1408 and a file storage subsystem 1410, user interface input devices 1412, user interface output devices 1414, and a network interface subsystem 1416.

Bus subsystem 1404 provides a mechanism for letting the various components and subsystems of computer system 1400 communicate with each other as intended. Although bus subsystem 1404 is shown schematically as a single bus, alternative embodiments of the bus subsystem may utilize multiple busses.

Processor 1402, which can be implemented as one or more integrated circuits (e.g., a conventional microprocessor or microcontroller), can control the operation of computer system 1400. In various embodiments, processor 1402 can execute a variety of programs in response to program code and can maintain multiple concurrently executing programs or processes. At any given time, some or all of the program code to be executed can be resident in processor 1402 and/or in storage subsystem 1406. Through suitable programming, processor 1402 can provide various functionalities described above for performing actions based on parameters when in a contactless operating mode.

Network interface subsystem 1416 provides an interface to other computer systems and networks. Network interface subsystem 1416 serves as an interface for receiving data from and transmitting data to other systems from computer system 1400. For example, network interface subsystem 1416 may enable computer system 1400 to connect to a client device via the Internet. In some embodiments network interface 1416 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments network interface 1416 can provide wired network connectivity (e.g., Ethernet) in addition to or instead of a wireless interface.

User interface input devices 1412 may include one or more sensors, a keyboard, pointing devices such as a mouse or trackball, a touchpad or touch screen incorporated into a display, a scroll wheel, a click wheel, a dial, a button, a switch, a keypad, audio input devices such as voice recognition systems, microphones, and other types of input devices. In general, use of the term “input device” is intended to include all possible types of devices, sensors and mechanisms for inputting information to computer system 1400. For example, in an iPhone®, user input devices 1412 may include one or more buttons provided by the iPhone®, a touch screen, and the like. A user may provide input regarding parameter setting and/or gesture recognition using one or more of input devices 1412.

User interface output devices 1414 may include a display subsystem, indicator lights, or non-visual displays such as audio output devices, etc. The display subsystem may be a cathode ray tube (CRT), a flat-panel device such as a liquid crystal display (LCD), a projection device, a touch screen, and the like. In general, use of the term “output device” is intended to include all possible types of devices and mechanisms for outputting information from computer system 1200. For example, menus and other options for performing functions in accordance with a contactless operating mode may be displayed to the user via an output device.

Storage subsystem 1406 provides a computer-readable storage medium for storing the basic programming and data constructs that provide the functionality of some embodiments. Storage subsystem 1406 can be implemented, e.g., using disk, flash memory, or any other storage media in any combination, and can include volatile and/or non-volatile storage as desired. Software (programs, code modules, instructions) that when executed by a processor provide the functionality described above may be stored in storage subsystem 1406. These software modules or instructions may be executed by processor(s) 1402. Storage subsystem 1406 may also provide a repository for storing data used in accordance with the present invention. Storage subsystem 1406 may include memory subsystem 1408 and file/disk storage subsystem 1410.

Memory subsystem 1408 may include a number of memories including a main random access memory (RAM) 1418 for storage of instructions and data during program execution and a read only memory (ROM) 1420 in which fixed instructions are stored. File storage subsystem 1410 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 1400 can be of various types including a personal computer, a portable device (e.g., an iPhone®, an iPad®), a workstation, a network computer, a mainframe, a kiosk, a server or any other data processing system. Due to the ever-changing nature of computers and networks, the description of computer system 1400 depicted in FIG. 14 is intended only as a specific example. Many other configurations having more or fewer components than the system depicted in FIG. 14 are possible.

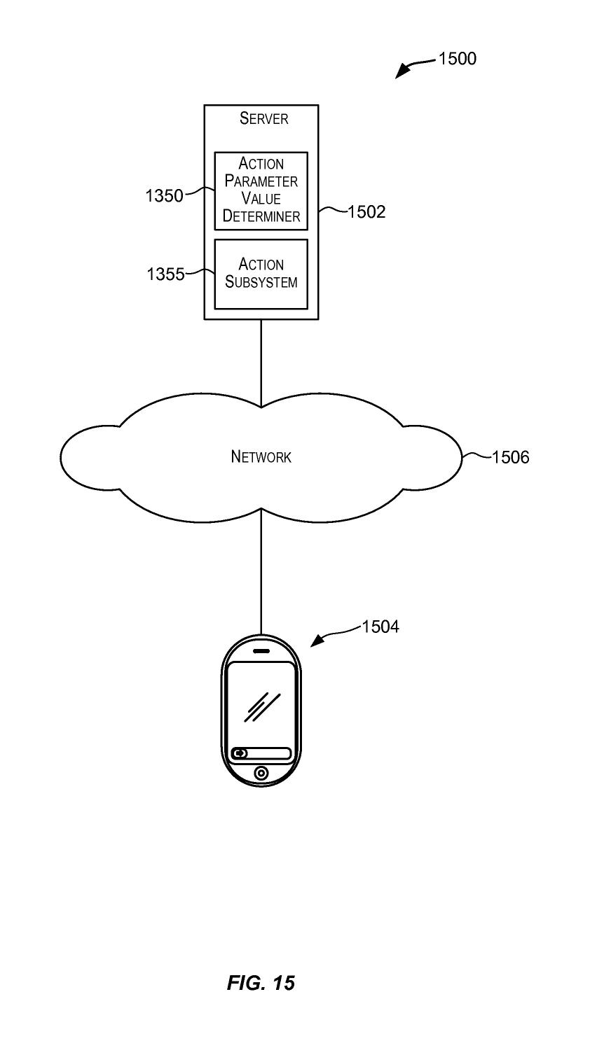

System 1300 depicted in FIG. 13 may be provided in various configurations. In some embodiments, system 1300 may be configured as a distributed system where one or more components of system 1300 are distributed across one or more networks in a cloud. FIG. 15 depicts a simplified diagram of a distributed system 1300 for providing an electronic device capable of performing an action related to a gesture according to some embodiments. In the embodiment depicted in FIG. 15, action parameter value determiner 1350 and action subsystem 1355 are provided on a server 1502 that is communicatively coupled with electronic device 1504 via network 1506.

Network 1506 may include one or more communication networks, which could be the Internet, a local area network (LAN), a wide area network (WAN), a wireless or wired network, an Intranet, a private network, a public network, a switched network, or any other suitable communication network. Network 1506 may include many interconnected systems and communication links including but not restricted to hardwire links, optical links, satellite or other wireless communications links, wave propagation links, or any other ways for communication of information. Various communication protocols may be used to facilitate communication of information via network 1306, including but not restricted to TCP/IP, HTTP protocols, extensible markup language (XML), wireless application protocol (WAP), protocols under development by industry standard organizations, vendor-specific protocols, customized protocols, and others.

In the configuration depicted in FIG. 15, electronic device 1504 may be used to detect a gesture and perform an action related to the gesture. For example, a user of electronic device 1504 may position an object in front of the electronic device. In one embodiment, electronic device 1504 may operate in a contactless mode and detect an attribute value of the gesture of the object, for example, the distance between electronic device 100 and the object. The attribute value information may be sent through network 1506 to server 1502 to action parameter value determiner 1350. Electronic device may further determine an action and send the action information through network 1506 to server 1502 to action parameter value determiner 1350 and to action subsystem 1355. Action parameter value determiner 1350 may receive data from both action detection subsystem 1320 and action determiner subsystem 1340. Action parameter value determiner 1350 may use data from action determiner subsystem 1340 to determine a parameter value for the action determined in 1340 based on the attribute value detected in 1320 and may send the parameter value to action subsystem 1355. Action subsystem 1355 may employ data supplied by action parameter value determiner 1350 and action determiner subsystem 1340 to perform an action. Action data from action subsystem 1355 may be sent through network 1506 to device 1504 to display subsystem 1360. In other embodiments any of the methods discussed in FIGS. 7-12 and variations thereof may be performed by distributing subsystems illustrated in FIG. 13 between electronic device 1504 and server 1502. Myriad combinations and configurations thereof are within the scope of this disclosure.

In the configuration depicted in FIG. 15, server 1502 is remotely located from electronic device 1504. In some embodiments, server 1502 may provide parameter setting and gesture recognition selection services to multiple clients. The multiple clients may be served concurrently or in some serialized manner. In some embodiments, the services provided by server 1502 may be offered as web-based or cloud services or under a Software as a Service (SaaS) model.

It should be appreciated that various different distributed system configurations are possible, which may be different from distributed system 1500 depicted in FIG. 15. The embodiment shown in FIG. 15 is thus only one example of a distributed system for providing an electronic device with gesture recognition and is not intended to be limiting.

Various embodiments described above can be realized using any combination of dedicated components and/or programmable processors and/or other programmable devices. The various embodiments may be implemented only in hardware, or only in software, or using combinations thereof. The various processes described herein can be implemented on the same processor or different processors in any combination. Accordingly, where components are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for interprocess communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

The various embodiments are not restricted to operation within certain specific data processing environments, but are free to operate within a plurality of data processing environments. Additionally, although embodiments have been described using a particular series of transactions, this is not intended to be limiting.

Thus, although the invention has been described with respect to specific embodiments, these are not intended to be limiting. Various modifications and equivalents are within the scope of the following claims.

What is claimed is:

1. A method comprising:
detecting, by a device, a touchless gesture made by an object relative to the device;
determining, by the device using one or more sensors of the device, an attribute value of the touchless gesture;
determining, by the device, an action to be performed based on the touchless gesture;
determining, by the device based upon the attribute value, a value for a parameter associated with the action; and
performing the action using the parameter value.

2. The method of claim 1 wherein:
the attribute value of the touchless gesture is a distance of the object from the device when the touchless gesture was made.

3. The method of claim 1 wherein:
the attribute value of the touchless gesture is a number of times the touchless gesture is repeated.

4. The method of claim 1 wherein:
the attribute value of the touchless gesture is a velocity of the object relative to the device when the touchless gesture was made.

5. The method of claim 2 wherein the determining the distance of the object from the device occurs after a user activates a contactless mode on the device.

6. The method of claim 5 wherein the contactless mode is activated by one of a user pushing a button, a user tapping the device or a user covering a sensor.

7. The method of claim 1 wherein the object is a portion of a user's body.

8. The method of claim 1 wherein the object is not a portion of a user's body.

9. The method of claim 1 wherein the device has a touch screen and the performing the action affects an image displayed on the touch screen.

10. The method of claim 9 wherein the action is one of a zoom or a pan of the image displayed on the touch screen.

11. The method of claim 1 wherein the action to be performed is determined based on the touchless gesture or a subsequent second touchless gesture.

12. A method comprising:
detecting, by a device, a first touchless gesture made by an object relative to the device;
determining, by the device using one or more sensors of the device, an attribute value of the first touchless gesture;
detecting, by the device, a second touchless gesture made by an object relative to the device;
determining, by the device, an action to performed based on the second touchless gesture;
determining, by the device based upon the attribute value, a value for a parameter associated with the action; and
performing the action using the parameter value.

13. The method of claim 12 wherein:
the attribute value of the first touchless gesture is a distance of the object from the device when the touchless gesture was made.

14. The method of claim 12 wherein:
the attribute value of the first touchless gesture is a number of times the touchless gesture is repeated.

15. The method of claim 12 wherein:
the attribute value of the first touchless gesture is a velocity of the object relative to the device when the touchless gesture was made

16. The method of claim 12 wherein:
the device comprises a first side that includes a display and a second side that is opposed to the first side; and
detecting the first touchless gesture comprises detecting the object is in a sensing zone positioned in front of the second side.

17. The method of claim 13 wherein determining the distance of the object comprises determining the distance between the object and a second side of the device.

18. The method of claim 12 wherein:
the device comprises a first side that includes a display and a second side that is opposed to the first side; and
the object is positioned in a sensing zone positioned in front of the first side.

19. The method of claim 13 wherein the distance is determined between the object and a first side of the device.

20. A non-transitory computer-readable storage medium storing a plurality of instructions for controlling a processor, the plurality of instructions comprising:
instructions that cause the processor to detect, using a device, a touchless gesture made by an object relative to the device;
instructions that cause the processor to determine, using one or more sensors of the device, a distance of the object from the device when the touchless gesture was made;
instructions that cause the processor to determine, an action to be performed;
instructions that cause the processor to determine, based upon the distance, a value for a parameter associated with the action; and
instructions that cause the processor to perform the action using the parameter value.
